(19) United States
(12) Patent Application Publication
(10) Pub. No.: US 2015/0165701 A1
(43) Pub. Date: Jun. 18, 2015

(54) Method of Manufacturing Paving Slabs

(71) Applicant: Gaudreau Environnement Inc., Victoriaville (CA)

(72) Inventor: Real Fortin, Victoriaville (CA)

(21) Appl. No.: 14/526,798

(22) Filed: Oct. 29, 2014

Related U.S. Application Data
(60) Provisional application No. 61/917,543, filed on Dec. 18, 2013.

(51) Int. Cl. B29C 70/58

(52) U.S. Cl. CPC B29C 70/58; B29K 2023/0633

(57) ABSTRACT

Paving slabs are molded from a mixture of recycled shredded plastic materials from sheet or film such as bags of a low density polyethylene, recycled ground glass and recycled ground china where the mixed materials are extruded with sufficient pressure so as to melt the plastics to bond together the glass and china particles to feed the materials into molds for forming the paving slab. The mixture contains plastics in the range 20 to 40 per cent by weight and preferably of the order of 2 percent, glass in the range 55 to 75 per cent and preferably of the order of 70 percent by weight and china in the range 2 to 6 per cent and preferably of the order of 4 percent by weight.

This application claims the benefit under 35 USC 119 (e) of Provisional Application 61/917543 filed Dec. 18, 2013.

This invention relates to a method of manufacturing paving slabs using recycled materials and particularly using recycled LDPE, glass and china.

### SUMMARY OF THE INVENTION

It is one object of the present invention to provide a method for recycled paving slabs made from recycled plastic, glass and china.

According to the invention there is provided a method for forming paving slabs comprising:
collecting recycled plastics materials of a low density polyethylene (LDPE #4);
treating the plastics materials so as to form shredded portions of the plastics material;
collecting recycled glass which is formed into a particulate material;
collecting recycled china which is formed into a particulate material; mixing the materials;
extruding the mixed materials with sufficient pressure so as to melt the plastics to bond together the glass and china particles;
and molding the extruded materials into a paving slab.

From the prior art, the present invention has the following significant differences:
a) The finished product is different in that there are manufactured paving slabs as opposed to plastic aggregate to mix with cement.
b) There is no cement involved in the present process.
c) The machinery used to melt the plastic and glass mixture comprises an extruder rather than that will mix the wastes once they are melted with the extruder machine. The prior art uses a heating device that will mix the wastes once they are melted.
d) The density of the product is much higher: 1350 kg/cubic meter as opposed to a density of the order of 800 kg/cubic meter.
e) The present invention does not use solid plastic; but instead uses plastic films, for example grocery bags.
f) The ratio for plastic versus glass is not the same. In typical arrangements the ratios described are:
   2:1=66.6% plastic/33.3% glass
   1:1=50% plastic/50% glass
   1:3=25% plastic/75% glass

The present arrangement uses a ratio of the order of 25% plastic and 71% glass with 4% added porcelain

The present arrangement uses recycled plastic films like grocery bags or other type of soft plastic classified has low density polyethylene (LDPE #4); recycled glass size 2.36 mm or less and recycled china (toilet or lavatory bowl) size 2.36 mm.

These materials when pressed at 2500 psi can create a product with a density equivalent to 1350 kg\cubic meter

In the materials pre-treatment, plastic films: the films must be treated in such a way that they are transformed into shredded plastic to properly feed the extruder. There is no washing treatment required.

The glass requires no transformation other than being sift out to extract proper size (maximum 2.36 mm)

The recycled toilet or lavatory bowl needs to go through a crusher and a sifter in order to obtain the proper size (2.36 mm)

All materials are weighed and pre-mixed together in batches to fit the extruder capacity.

In regard to the equipment, there is provided the following:
Granulator to granulate the plastic film;
Crusher to crush the toilet or lavatory bowl;
Trommel screen to sift the glass and china to proper size;
Silos to store materials;
Balance to weigh the materials;
Mixer to mix the materials together;
Distributor to feed the extruder;
Extruder to melt and mix the materials together ±300 to 400 Fahrenheit;
Robot to collect melted mixture and feed the press;
Press and molds to give proper shape;
Robot to remove finished slabs for stocking.

In the extruder heat is generated by friction and by heaters. When the material is loaded in the chamber, it is cold. When the system is started the heat builds up in the chamber by friction and by heaters and acts to melt the added material.

The molding is done with a press using male female die. The die may be fabricated with special patterns to get the desired paving slab designs

### BRIEF DESCRIPTION OF THE DRAWINGS

One embodiment of the invention will now be described in conjunction with the accompanying drawings in which:

FIG. 1 shows a schematic layout of the process.

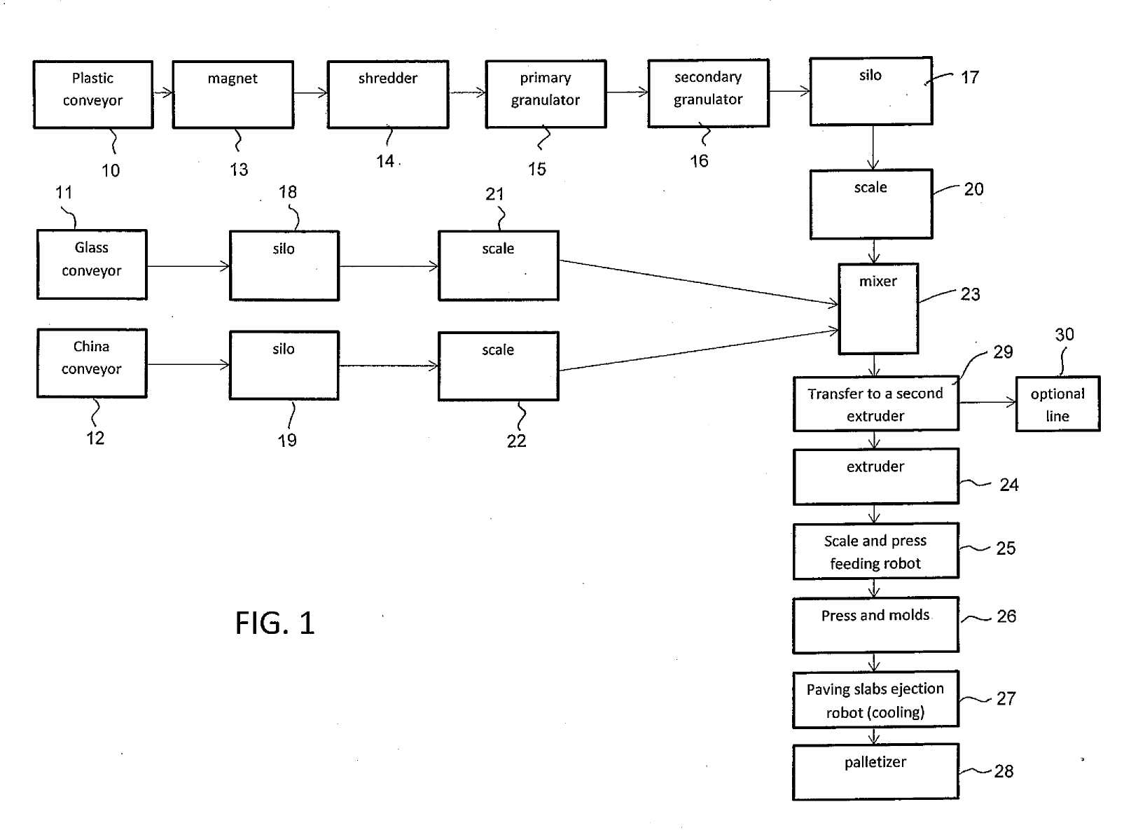

### DETAILED DESCRIPTION

Recycled materials obtained from household or other collected materials including recycled LDPE and recycled glass and porcelain. These materials are typically separated annually and supplied on different conveyors 10, 11 and 12.

The plastics materials on the conveyor 13 are passed through a magnetic separator 13 to remove any metal, a shredder 14, a primary granulator 15 and a secondary granulator 16 so as to break down the plastics materials into the shredded portions as set out hereinafter. The glass and porcelain is ground to provide the particulate material required for the process. These materials are supplied on the conveyors 10, 11 and 12 and are stored in silos 17, 18 and 19.

The waste materials are then weighed in scales 20, 21 and 22 to provide the required batches for the formula required are then carried to the mixer 23. When the mixture is ready it will fall in the distributer 29. The distributer 29 will then feed the extruder 24. The press feeding robot 25 will take the aggregate mixture and carry it to rotative press 25 to mold the paving slabs in the molds 26. When the molding cycle is done, the ejection robot 27 will remove the slabs from the press and carry the finished product for stocking.

Key differences in the present invention are that the system uses glass instead of sand and that recycled porcelain is added to the mixture.

Thus the method includes the steps of:
collecting recycled plastics materials of a low density polyethylene (LDPE #4) on the conveyor 10;
treating the plastics materials in the form of bags or other sheet material in the steps 13, 14 and 15 so as to form shredded portions of the plastics material;
collecting recycled glass on the conveyor 11 which is formed into a particulate material;
collecting recycled china on the conveyor 12 which is formed into a particulate material;
mixing the materials at the mixer 23;
extruding the mixed materials in the extruder 24 with sufficient pressure so as to melt the plastics to bond together the glass and china particles;
and molding the extruded materials into a paving slab in the molds 26.

In order to melt the plastics to bond together the glass and china particles, the materials are compressed at a pressure in the range 1500 to 3500 psi and preferably of the order of 2500 psi.

This mixture and pressure causes that the materials are compressed to a product with a density in the range 1000 to 1500 kg/cubic meter and preferably of the order of 1350 kg/cubic meter when pressed at 2500 psi.

The extruder 24 where the mixed materials generates heat for melting the plastics by the pressure applied so that the mixed materials are heated by the extruder to a temperature in the range 300 to 400 degrees Fahrenheit

The plastics materials on the conveyor 10 can be provided as plastic films from conventional reclamation systems.

In view of the use of the high pressure heating there is no washing treatment of the plastics materials required.

The glass on the conveyor is crushed or ground to a required particulate size but requires no transformation other than conventional grading to sift out to extract proper size where the glass and china have a maximum particle size in the range 0.1 to 2.36 and preferably of the order of 2.36 mm.

The china is formed from recycled toilet or lavatory bowl.

The scales 20, 21, 22 are operated to supply the mixer 23 with the materials which are mixed in the following amounts:
plastics materials in the range 20 to 40 per cent and preferably of the order of 25% percent by weight;
glass in the range 55 to 75 per cent and preferably of the order of 70% percent by weight;
china in the range 2 to 6 per cent and preferably of the order of percent 4% by weight;

The molds are fabricated with special patterns to get the desired paving slab designs.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A method for forming paving slabs comprising:
collecting recycled plastics materials of a low density polyethylene (LDPE #4);
collecting recycled glass which is formed into a particulate material;
collecting recycled china which is formed into a particulate material;
mixing the materials;
extruding the mixed materials with sufficient pressure so as to melt the plastics to bond together the glass and china particles;
and molding the extruded materials into a paving slab.

2. The method according to claim 1 wherein the materials are compressed at a pressure in the range 1500 to 3500 psi and preferably of the order of 2500 psi.

3. The method according to claim 1 wherein the materials are compressed to a product with a density in the range 1000 to 1500 kg/cubic meter and preferably of the order of 1350 kg/cubic meter.

4. The method according to claim 1 wherein the mixed materials are extruded in a extruder.

5. The method according to claim 1 wherein the mixed materials are heated by the extruder to a temperature in the range 300 to 400 degrees Fahrenheit

6. The method according to claim 1 wherein the plastics materials are provided as plastic films.

7. The method according to claim 1 wherein there is no washing treatment of the plastics materials required.

8. The method according to claim 1 wherein the plastics films are fed to a granulator to granulate the plastic film.

9. The method according to claim 1 wherein the glass is crushed or ground to a required particulate size but requires no transformation other than being sift out to extract proper size

10. The method according to claim 1 wherein the glass and china have a maximum particle size in the range 0.1 to 2.36 and preferably of the order of 2.36 mm.

11. The method according to claim 1 wherein the china is formed from recycled toilet or lavatory bowl.

12. The method according to claim 1 wherein the materials are mixed in the following amounts:
plastics materials in the range 20 to 40 per cent and preferably of the order of 25% percent by weight
glass in the range 55 to 75 per cent and preferably of the order of 70% percent by weight
china in the range 2 to 6 per cent and preferably of the order of percent 4% by weight

13. The method according to claim 1 wherein the materials consist solely of the plastics, glass and china.

14. The method according to claim 1 wherein the mixed materials contain no binder apart from the plastics materials.

15. The method according to claim 1 wherein the extruded material is formed in a mold to give proper shape.

16. The method according to claim 15 wherein the mold is fabricated with special patterns to get the desired paving slab designs.

17. The method according to claim 1 including treating the plastics materials in sheet form so as to shred the plastics material.
